(19) United States
(12) Patent Application Publication
(10) Pub. No.: US 2009/0266922 A1
(43) Pub. Date: Oct. 29, 2009

(54) SECURE NOZZLE INSERT ASSEMBLY

(76) Inventors: Stuart Morgan, Victoria (AU); Sean Morgan, Victoria (AU)

Correspondence Address: EDWIN D. SCHINDLER, FIVE HIRSCH AVENUE, P.O. BOX 966, CORAM, NY, 11727-0966, US

(21) Appl. No.: 12/301,237

(22) PCT Filed: May 21, 2007
(86) PCT No.: PCT/AU07/00695

§ 371 Date: Nov. 18, 2008

(30) Foreign Application Priority Data
May 19, 2006 (AU) 2006902696
Jul. 31, 2006 (AU) 2006904114

(51) Int. Cl. B05B 1/00

(52) U.S. Cl. 239/589

(57) ABSTRACT

A metallic spray nozzle having a counterbore from one side thereof into which an insert to control the spray is located and retained by way of a retaining lip formed by deformation of the outer periphery of the counterbore. This deformation can be toward an axis of the nozzle or, alternatively, this deformation can subsequently direct the tip of the periphery outwards at its extremity such that flow into the counterbore is smooth. An O-ring or other sealing membrane is provided between a locating shoulder in the nozzle body and the insert, and an insert shield between the insert and the retaining lip.

### AREA OF THE INVENTION

This invention relates to a nozzle which contains inserts and particularly to a spray nozzle for use in applications where extreme temperatures are met by the nozzle or where fragile components must be retained without damage.

### BACKGROUND TO THE INVENTION

Nozzles of the type to which this specification will refer are a commodity item used in very large numbers and can be threaded directly into pipe, or to attachments to which pipes are connected to provide a spray and in a conventional application there can be a substantial number of these nozzles along a particular length of pipe-work.

The nozzles themselves can vary from nozzles which are very small, having an overall body diameter of the order of 1 centimetre up to nozzles which are substantially larger than this.

In practice the nozzles may be turned from a metallic rod, normally brass but possibly stainless steel, or are cast and later milled. In order to ensure good distribution and spray pattern from the nozzle it is quite usual that the line end of the nozzle is counter-bored and receives an insert which can, for example, impart a rotatory motion to the fluid as it passes into the nozzle and a variety of other types of patterns such as solid jet, needle jet or flat fan.

These inserts may be cast or machined and are normally a frictional fit within the nozzles. Such nozzles are quite satisfactory in general use however there are situations where the conventional nozzles are less than satisfactory and one of these is where the nozzles are used to spray very hot materials. In one such application the nozzles may be used to spray a liquid onto a metal rod or sheet before rolling where the metal is “red hot”.

For the liquid to reach the surface of the metal it is necessary that the nozzles be located very close to the surface and in practice it has been found that the expansion of the nozzle tends to be differential so that the inserts are no longer held within the nozzles but are in effect basically free floating.

If there then happens to be any form of reverse pressure, either because of a fluctuation in the fluid line pressure or possibly even through evaporation of liquid in the nozzles, or should there be any physical movement as by vibration or hammer in the pipes, then the insert can leave the nozzle and pass into the line.

If this occurs then there can be a partial blockage of the line or of a particular other nozzle, if the insert stops in the line, and in order to correct this the spraying operation has to be stopped, the insert has to found and removed and, of course, the faulty nozzle has to be replaced. Where the system is being used in a time critical situation, such as with a steel rolling mill, this can be extremely expensive as the line may have to be stopped for repair.

It has been known to provide a retaining means for an insert in a nozzle by at least partially peening over the end of the counter-bore to prevent movement of the insert.

In that particular type of nozzle the lip of the end of the counter-bore is shaped during manufacture to be tapering towards the end of the lip and a die or the like is used to form the lip so as to retain the insert whilst at the same time ideally providing no specific intrusion which could adversely affect fluid flow in the line.

In practice however it has been found that the crimping does cause some degree of turbulence in the flow into the back of the nozzle.

A further problem with the the inserts as retained in this manner is that they are subject to high pressure leakage. In addition they can be damaged during the crimping process, this is particularly so for Ruby or ceramic inserts as used in high pressure washing, trimming and cutting applications of the type typically found in paper mills and other such industries.

An additional problem that relates to ruby and ceramic inserts is that in brush showers. and the like, where the internal longitudinal rotating brush cleans the nozzle nipple that protrudes into the pipe, damage can be caused to the inserts. This is because such edges are more fragile in shear and can be chipped or damaged by the brush bristles.

### OUTLINE OF THE INVENTION

It is an object of the invention to provide a nozzle having an insert which is retained by crimping as described above but having smoother flow into the back of the nozzle when compared with previous such nozzles.

It is a further object of the invention to provide such a nozzle which is sealed so as to prevent high pressure leakage without the use of glues and the like. It is also an object of the invention to provide a means for protecting that part of the insert, where it is ruby or ceramic, from damage by cleaning brush bristles.

The invention in one aspect is a metallic spray nozzle having a counterbore from one side thereof into which an insert to control the spray is located and retained by means of deformation of the outer periphery of the counterbore.

This deformation can in one embodiment of the invention be towards an axis of the nozzle.

In a further embodiment of the invention this deformation can be firstly towards an axis of the nozzle and subsequently outwards at its extremity such that flow into the counterbore is smooth.

The invention in a second aspect is a metallic spray nozzle having a counterbore from one side thereof into which a Ruby or ceramic or other such insert is located and retained by means of deformation of the outer periphery of the counterbore towards an axis of the nozzle having an O ring or other sealing membrane between a locating shoulder in the nozzle body and the inside edge of the insert.

The invention in a third aspect is an insert shield which is an annular shape with a central aperture and extends in a tapering fashion from within the outer periphery of the nozzle towards the aperture.

In order that the invention may be more readily understood we shall describe by way of non limiting example embodiments of the nozzle made in accordance with the invention as shown in the drawing figures.

### BRIEF DESCRIPTION OF THE DRAWING FIGURES

FIG. 1 Is a cross-sectional view of the nozzle after peening;

FIG. 2 Shows a schematic view of the formation of an inwardly directed crimp;

FIG. 3 Shows a schematic view of the formation of a retaining lip having an outwardly directed upper edge;

FIG. 4 Shows a perspective view of an insert shield;

FIG. 5 Shows a diagrammatic cross-section through an assembled nozzle with sealing means, insert, insert shield and retaining lip;

### DESCRIPTION OF EMBODIMENTS OF THE INVENTION

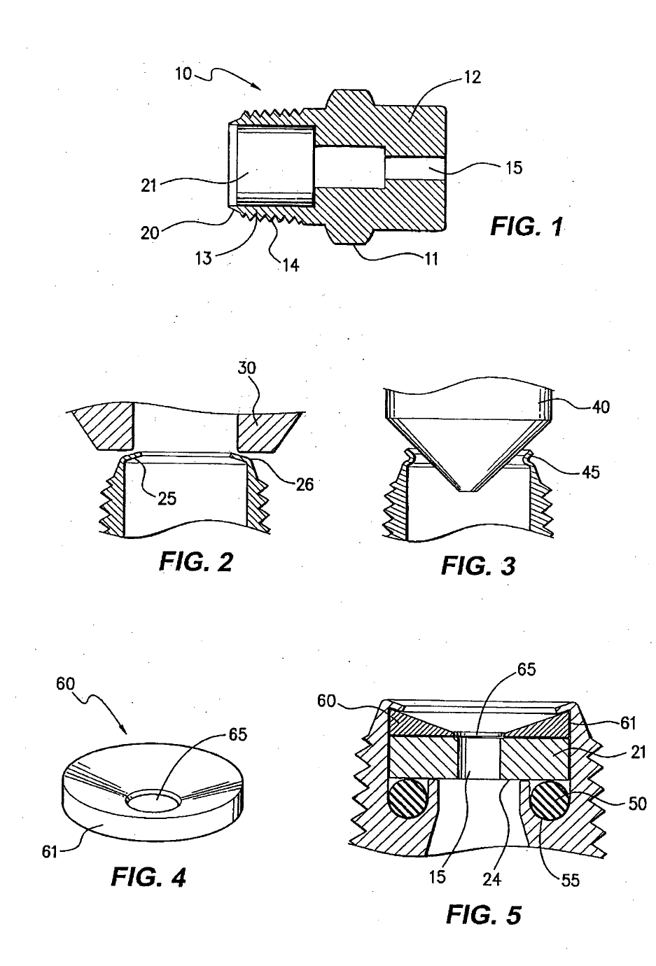

The nozzle of the invention 10 is basically be considered conventional and is shown in FIG. 1 It can be either machined from a metallic rod or cast and machined and is generally cylindrical having part way along its outer length lands 11 or the like which provide a hexagonal shape to permit the nozzle to be rotated by a spanner or the like.

At one end 12 the nozzle is closed with an aperture 15 there through forming the actual orifice of the nozzle while the other end 13 is open by the formation of a counter-bore thereinto and is threaded 14 on its outer surface.

The nozzle of the invention differs from conventional nozzles only in that there is a tapered portion 20 at the outer end of the thread, which can be peened or otherwise deformed towards the counterbore axis. This tapered portion can be formed after the thread has been cut and, possibly, in the same operation as the thread cutting operation.

When the nozzle is assembled and an insert is located therein and the outer edge of the insert 21 terminates adjacent the inner part of the tapered portion 25. An annular die 30 in a press can then be moved down over the tapered portion and cause an inward deformation or crimping of the outer edge 26 of the nozzle 10 which provides a retaining lip which acts as a barrier to prevent the insert from leaving the nozzle.

A flaring tool 40 can then be inserted into the counterbore to deform the outermost edge outwards to create a flared crimp 45 as shown in FIG. 3 so that the fluid entering the nozzle passes a smooth curved edge when it passes the retaining lip which does not contribute to turbulence of the fluid in this area.

Where the insert is a ceramic, ruby or other such insert having a central aperture these inserts also are retained by the rolled lip procedure described earlier. Such an insert requires a very good seal to be achieved as higher pressures are involved and there is a greater opportunity for liquid streams to find a passage between the insert and the body and to intersect the primary liquid jet thereby severely disturbing it.

In order to provide such a seal, as shown in FIG. 4 an O ring 50 or other sealing membrane is located between a shoulder 55 in the nozzle body and an inner face 24 of the insert. While this provides the effective seal required there is the added advantage that the crimping pressure required to create a seal is reduced as the compression on the rubber O ring enhances the seal.

A further advantage is that the insert is cushioned by the O ring during the crimping process and is therefore less likely to be damaged.

As previously stated however ruby and ceramic inserts are vulnerable to damage caused by the bristles of cleaning brushes.

This problem is addressed in the invention by providing an insert shield 60 as shown in FIG. 4 which generally covers the ruby or ceramic surface 27 and is located within the peened periphery.

This insert shield 60 is a circular component with a central aperture 65 which is located inside the peened periphery of the nozzle and tapers in thickness from its periphery 61 towards its central aperture and the nozzle orifice 15.

This tapering effect further stabilizes the spray by allowing liquid not entering the nozzle orifice to smoothly exit the orifice area by following the taper out rather than exiting across the insert face, hitting the crimp and causing turbulence.

By the means described above significant improvements are provided in prior rolled lip insert retaining type nozzles and whilst we have described herein specific embodiments of the invention it is envisaged that other embodiments of the invention will exhibit any number of and any combination of the features previously described and it is to be understood that variations and modifications in this can be made without departing from the spirit and scope of the invention.

1-7. (canceled)

8. A metallic spray nozzle, comprising a counterbore from one side thereof into which an insert for controlling a spray located, and retained, via a retaining lip formed by deformation of an outer periphery of the counterbore toward an axis of said metallic spray nozzle, said insert having a central aperture between an inner face an outer face thereof.

9. The metallic spray nozzle according to claim 8, further sealing means between a locating shoulder in said metallic spray nozzle and the inner face of said insert.

10. The metallic spray nozzle according to claim 9, wherein said sealing means is an O-ring.

11. The metallic spray nozzle according to claim 8, further comprising an insert shield having a central aperture located between an outer surface of said insert and said retaining lip, and extending from an inner periphery of said metallic spray nozzle toward the central aperture of said insert shield.

12. The metallic spray nozzle according to claim 11, wherein said insert shield has an annular shape and extends, in a tapering fashion from an inner periphery of said metallic spray nozzle toward an aperture of said metallic spray nozzle.

13. The metallic spray nozzle according to claim 11, wherein said insert shield is a ruby insert shield.

14. A metallic spray nozzle, comprising a counterbore from one side thereof into which an insert for controlling a spray located, and retained, via a retaining lip formed by deformation of an outer periphery of the counterbore, initially, toward an axis of said metallic spray nozzle and, subsequently, outwardly so that flow into the counterbore is smooth.

15. The metallic spray nozzle according to claim 14, further sealing means between a locating shoulder in said metallic spray nozzle and the inner face of said insert.

16. The metallic spray nozzle according to claim 15, wherein said sealing means is an O-ring.

17. The metallic spray nozzle according to claim 14, further comprising an insert shield having a central aperture located between an outer surface of said insert and said retaining lip, and extending from an inner periphery of said metallic spray nozzle toward the central aperture of said insert shield.

18. The metallic spray nozzle according to claim 17, wherein said insert shield has an annular shape and extends, in a tapering fashion, from an inner periphery of said metallic spray nozzle toward an aperture of said metallic spray nozzle.

19. The metallic spray nozzle according to claim 17, wherein said insert shield is a ruby insert shield.
